(19) United States
(12) Patent Application Publication
(10) Pub. No.: US 2016/0102815 A1
(43) Pub. Date: Apr. 14, 2016

(54) MULTI-FUNCTION BOATING LIGHT

(71) Applicants: Tom Gregory Bailey, Ada, MI (US); Kevin Downey, Rockford, MI (US); Adrian Draghici, Grand Rapids, MI (US)

(72) Inventors: Tom Gregory Bailey, Ada, MI (US); Kevin Downey, Rockford, MI (US); Adrian Draghici, Grand Rapids, MI (US)

(21) Appl. No.: 14/510,768

(22) Filed: Oct. 9, 2014

(51) Int. Cl. F21K 99/00; F21V 23/02; F21V 23/04; F21V 21/088; B63B 45/00

(52) U.S. Cl. CPC F21K 9/30; F21V 21/088; B63B 45/00; F21V 23/04; F21V 23/023; F21Y 2113/005

(57) ABSTRACT

A multi-function boating light is described. The apparatus comprises a light fixture operatively coupled to a housing, the light fixture comprising a bezel, a lens, and a printed circuit board. Light emitting diodes are disposed on the printed circuit board. A first portion of the light emitting diodes emits first type of light and a second portion of the light emitting diodes emits a second type of light, the second type of light being different than the first type of light.

### FIELD OF THE DISCLOSURE

This disclosure relates generally to boating lights and, more particularly, to multi-function boating lights.

### BACKGROUND

Boating lights may be used for a variety of purposes, including flood lighting, navigation lighting, dock lighting, and underwater lighting. Lighting may be used while night fishing to improve night vision and visibility of fluorescent objects. Different types of light may be used for different purposes. For example, bright white light may be used for flood lighting, while red light may be used to improve night vision, and ultra-violet (UV) light may be used to illuminate fluorescent objects, such as fishing line and lures. Typically, these different types of light are provided via different light fixtures.

Boating lights may be either permanently mounted or removably attached to a boat. Removable lights are typically attached to the boat using clamps or similar devices, which may be adjustable to attach to a variety of locations on a variety of boats. Clamps may be attached to the light in a manner that allows the light to be positioned in a variety of orientations.

### BRIEF DESCRIPTION OF THE DRAWINGS

FIG. 1 depicts an example apparatus in accordance with the teachings herein.

FIG. 2 is a perspective view of the example apparatus of FIG. 1.

FIG. 3 is an exploded view of the example apparatus of FIGS. 1 and 2.

### DETAILED DESCRIPTION

The example apparatus described herein is a boating light containing a light fixture using light emitting diodes (LEDs) and having multiple operational modes. Each operational mode illuminates LEDs emitting a different type of light. The LEDs of the example apparatus are organized into rows based on which type of light each LED emits such that each row or set of rows of LEDs corresponds to a different type of light and operational mode. The types of light emitted by the example apparatus include bright white light, red light, and ultra-violet (UV) light. However, additional, fewer and/or other combinations of light types could be used to suit the needs of a particular application. Each type of light may be used to perform a different task while night fishing (e.g., improving night vision, improving visibility of lures, etc.). Buttons (e.g., switches) integrated with the example apparatus may be depressed or otherwise actuated to select one or more of the operational modes. Specifically, the buttons control the illumination of the LEDs such that each button corresponds to or is dedicated to a different operational mode and type of light. However, other example apparatus may use a single button or selector to control all types of lighting and/or operational modes. The single button or selector may be actuated more than once or moved through multiple positions to select the different operational modes and types of light emitted by the example apparatus.

The example apparatus described herein may be attached to a marine craft or vehicle via an adjustable clamp. However, other example apparatus may use other attachment mechanisms. The example apparatus described herein may also be rotated or angled about the clamp via a pivot disposed between the clamp and the light fixture. A knob of the pivot may be loosened to allow movement of the example light fixture or tightened to prevent movement of the light fixture. The example apparatus further includes a battery compartment having a removable cover coupled to the light fixture via fasteners (e.g., screws, clips).

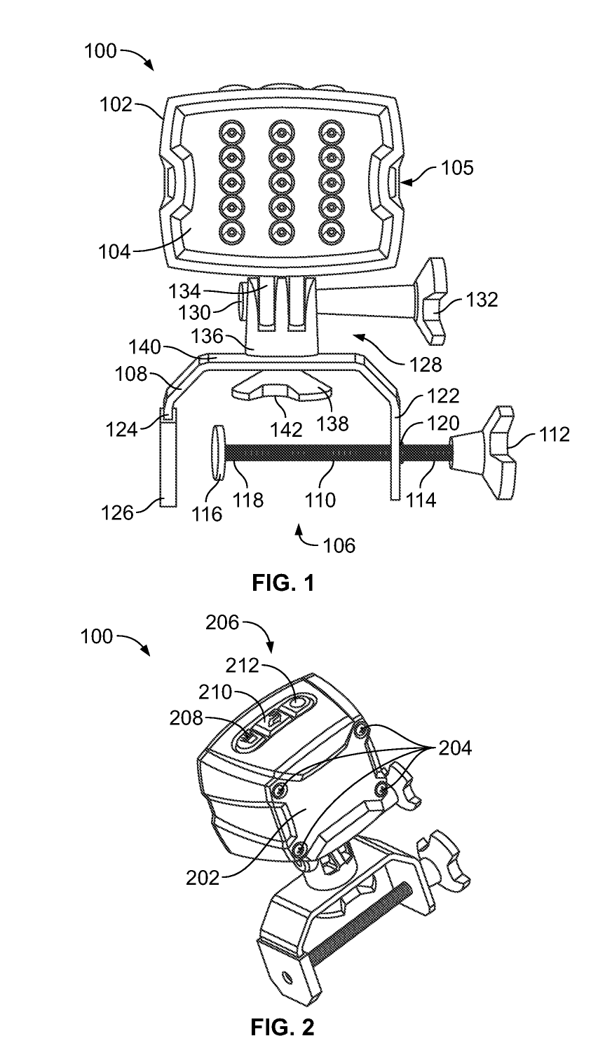

An example apparatus 100 of FIG. 1 is depicted as a boating light. The example apparatus 100 includes a housing (e.g., body) 102 containing a light fixture 104, which may include multiple components (e.g., a lens, a bezel, and/or circuitry or electronics). The housing 102 may be composed of any durable, water resistant material (e.g., plastic). The example light fixture 104 has five rows of LEDs 105, but may have any number of rows of LEDs 105. The LEDs 105 of the example apparatus 100 are grouped in rows according to the type of light emitted by the LEDs. For example, the top two rows of the example light fixture 104 emit bright white light (approximately 500 Lumens) to act as a flood light. The middle row of the example light fixture 104 emits red light (approximately 50 Lumens) to aid in night vision. The bottom two rows of the example light fixture 104 emit ultra-violet (UV) light to increase visibility of fluorescent objects (e.g., fishing lures, fishing line).

The example apparatus 100 further includes a clamp 106. The clamp 106 is adjustable to enable the light fixture 104 to be removably attached to a marine craft or vehicle in a variety of locations. The clamp 106 includes a bracket 108 and a threaded rod 110 to facilitate attachment. The threaded rod 110 has a first knob 112 disposed on a first end 114. The first knob 112 may be rotated to adjust (e.g., translate) the threaded rod 110. A disc 116 may be disposed on a second end 118 of the threaded rod 110. The disc 116 may be made of a material (e.g., rubber) to prevent the marine craft or vehicle from being damaged by the second end 118 of the threaded rod 110. The threaded rod 110 passes through an aperture 120 of a first side 122 of the bracket 108. The first knob 112 may adjust the threaded rod 110 to move the second end 118 of the threaded rod 110 closer to or further from a second side 124 of the bracket 108 to securely attach (e.g., clamp) the example apparatus 100 to a location on a marine craft or vehicle. The second side 124 of the bracket 108 may be partially covered by a boot 126, which may be made of a material (e.g., rubber) to prevent the bracket 108 from damaging (e.g., scratching, gouging, etc.) the marine craft or vehicle. The boot 126 may be removably coupled or permanently fixed to the second side 124 of the bracket 108.

A pivot 128 may be disposed between the housing 102 and the clamp 106. The pivot 128 is coupled to the housing 102 via a pin 130 coupled to a second knob 132. The example pivot 128 includes an upper portion 134 and a lower portion 136. The pin 130 is disposed through coaxially aligned apertures in the upper and lower portions 134 and 136 of the pivot 128. The pin 130 of example apparatus 100 may be adjustable via threaded connections, allowing movement of the pivot 128 when loosened and restricting movement of the pivot 128 when tightened. The second knob 132 facilitates loosening and/or tightening the pin 130. Each of the upper and lower portions 134 and 136 has of a number of flanges (e.g., 2 flanges for the upper portion 134 and 3 flanges for the lower portion 136) rotatably fitted together with the pin 130 to allow the housing 102 and light fixture 104 to rotate about the pin 130. The lower portion 136 of the pivot 128 is coupled to a third knob 138 to enable rotation of the light fixture 104 relative to the clamp 106 (e.g., 360° rotation). The third knob 138 may be disposed on a top portion 140 of the bracket 108 and may be padded or made of a material (e.g., rubber) to prevent the marine craft or vehicle from being damaged (e.g., scratched). The third knob 138 of the example apparatus 100 may also have a textured surface 142 to facilitate gripping of a surface of a marine craft or vehicle by the third knob 138 to aid in secure attachment of the example apparatus 100 to the marine craft or vehicle.

Referring now to FIG. 2, the example apparatus 100 also comprises a battery compartment (not shown) protected by a removable cover 202. The cover 202 of example apparatus 100 is attached by fasteners 204 (e.g., screws, clips, etc.). The example apparatus 100 has four fasteners 204, but any number of fasteners may be used to attach the cover 202 to the housing 102.

As shown in FIG. 2, buttons 206 are disposed on the housing 102 of example apparatus 100. The buttons 206 include three individually actuable buttons 208, 210, and 212 in this example, but other examples may have a different number of buttons. In some examples, a single button or switch may be disposed on the housing, where the single button may be actuated to illuminate LEDs emitting more than one type of light. For example, depressing the button once may illuminate LEDs emitting a first type of light, depressing the butting twice may illuminate LEDs of a second type of light, etc. Another example may include a switch having multiple functional positions, where each position corresponds to a different type of light and operational mode.

In the example apparatus 100 of FIGS. 1 and 2, each of the buttons 208, 210, and 212 may be actuated (e.g., depressed) to illuminate LEDs 105 emitting a different type of light. For example, the leftmost button 208 in FIG. 2 may be actuated to illuminate LEDs 105 emitting white light, while the middle button 210 may be actuated to illuminate LEDs 105 emitting ultraviolet (UV) light and the rightmost button 212 may be actuated to illuminate LEDs 105 emitting red light. In the example apparatus 100, any combination of the buttons 208, 210, and 212 may be independently actuated to illuminate corresponding LEDs 105 (e.g., multiple types of light may be emitted) simultaneously. However, in other examples, only one type of light may be emitted at a given time.

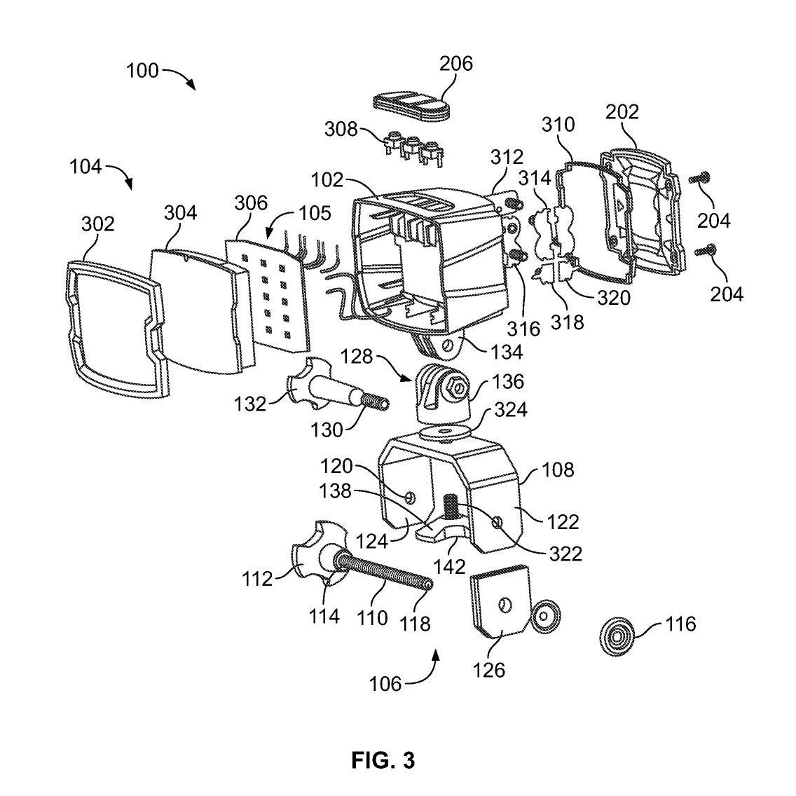

FIG. 3 is an exploded view of example apparatus 100 of FIGS. 1 and 2. As shown in FIG. 3, the housing 102 of example apparatus 100 contains the light fixture 104, which includes a bezel 302, a lens 304 and a printed circuit board (PCB) 306. The bezel 302 surrounds and fixes the lens 304 to the housing 102. The lens 304 protects the PCB 306, which contains the LEDs 105 and other circuitry or electronics, from damage. The PCB 306 is operatively coupled to the buttons 206, which protect (e.g., covering) switches 308 disposed within the housing 102. The switches 308 may be single-pole, single-throw devices that can toggle between electrically open and closed positions in response to being pushed or depressed by a person.

Components of a battery compartment are also disposed within the housing 102 and protected by the cover 202. A seal 310 (e.g., gasket) is disposed between the cover 202 and the housing 102. The seal 310 prevents water from entering the battery compartment and the fasteners 204 (not all of which are shown) ensure the cover 202 is tightly attached to the housing 102 to clamp the seal 310. The battery compartment also contains contact sets 312, 314, 316, 318, and 320 that may contain only negative contacts, only positive contacts, or both negative and positive contacts. The contact sets 312, 314, 316, 318, and 320 may be arranged such that the negative contacts and positive contacts are alternating and/or the negative and positive contacts are placed directly across from one another in the battery compartment to convey electrical energy for one or more batteries to the PCB 306. In this example apparatus 100, standard batteries may be interposed between contacts (e.g., between a negative and a positive contact). In other examples, other types of batteries or power sources may be used.

As shown in FIG. 3, the lower portion 136 of the pivot 128 is coupled to the bracket 108 via a threaded portion 322 of the third knob 138 and a washer 324 disposed between the clamp 106 and the lower portion 136 of the pivot 128.

Although certain apparatus, methods, and articles of manufacture have been described herein, the scope of coverage of this patent is not limited thereto. To the contrary, this patent covers all apparatus, methods, and articles of manufacture fairly falling within the scope of the appended claims either literally or under the doctrine of equivalents.

1. An apparatus comprising:
a light fixture operatively coupled to a housing, the light fixture comprising a bezel, a lens, and a printed circuit board, the lens defining a first face of the housing, the lens including a flange extending into the housing, the bezel to surround the lens and fix the lens to the housing; and
light emitting diodes disposed on the printed circuit board, wherein a first portion of the light emitting diodes emits first type of light and a second portion of the light emitting diodes emits a second type of light, the second type of light being different than the first type of light.

2. The apparatus as defined in claim 1 further comprising a third portion of the light emitting diodes emitting a third type of light different than the first and second types of light.

3. The apparatus as defined in claim 2, wherein the light emitting diodes are arranged in rows corresponding to the first, second, and third types of light.

4. The apparatus as defined in claim 3, wherein the first and second portions contain different numbers of light emitting diodes.

5. The apparatus as defined in claim 2 further comprising a first switch to control at least the first portion of the light emitting diodes.

6. The apparatus as defined in claim 5, wherein the first switch is to control the first, second and third portions of the light emitting diodes.

7. The apparatus of claim 5 further comprising a second switch to control the second portion of the light emitting diodes.

8. The apparatus of claim 7 further comprising a third switch to control the third portion of light emitting diodes.

9. The apparatus of claim 1 further comprising an adjustable clamp operatively coupled to the housing.

10. The apparatus of claim 1 further comprising a pivot operatively coupled to the housing to enable orientation of the housing in a plurality of directions, wherein the pivot may be set to restrict movement of the housing.

11. The apparatus of claim 1 further comprising a removable power source operatively coupled to the housing.

12. The apparatus as defined in claim 1, wherein the first and second portions of the light emitting diodes may emit light simultaneously.

13. An apparatus comprising:
light emitting diodes disposed in a housing, wherein the housing is to be attached to a boat and the light emitting diodes are separated into two or more portions, each portion emitting a type of light different than the type of light emitted by the other portion or portions, each type of light for night fishing;
a lens to define a face of the housing, the lens including a flange extending into the housing;
a bezel surrounding the lens to fix the lens to the housing; and
one or more switches operatively coupled to the light emitting diodes, the one or more switches to illuminate, when actuated, a portion or portions of light emitting diodes.

14. The apparatus as defined in claim 13, wherein a first one of the switches, when actuated, illuminates a first portion of light emitting diodes emitting a first type of light, wherein the first portion of light emitting diodes is disposed in a first row.

15. The apparatus of claim 14, wherein the first one of the switches, when actuated a second time or to a second portion, illuminates a second portion of light emitting diodes emitting a second type of light, wherein the second portion of light emitting diodes is disposed in a second row.

16. The apparatus of claim 15, wherein the first one of the switches, when actuated a third time or to a third portion, illuminates a third portion of light emitting diodes emitting a third type of light, wherein the third portion of light emitting diodes is disposed in a third row.

17. The apparatus as defined in claim 14, wherein a second one of the switches, when actuated, illuminates a second portion of light emitting diodes emitting a second type of light, wherein the second portion of light emitting diodes is disposed in a second row.

18. The apparatus as defined in claim 17, wherein a third one of the switches, when actuated, illuminates a third portion of light emitting diodes emitting a third type of light, wherein the third portion of light emitting diodes is disposed in a third row.

19. A boating light comprising:
means for selecting;
means for emitting light operatively coupled to the means for selecting, wherein the means for emitting light emits a plurality of types of light used for night fishing; and
means for attaching the means for emitting to a marine craft, the means for attaching including a means for adjusting to be rotated to adjust the means for attaching, the means for adjusting to be rotated to translate the means for adjusting in a first direction to move a first surface of the means for attaching further from a second surface of the means for attaching and the means for adjusting to be rotated to translate the means for adjusting in a second direction to move the first surface of the means for attaching closer to the second surface of the means for attaching to adjust the means for attaching.

20. The boating light as defined in claim 19, wherein the means for emitting light emits a light for improving night vision, increasing the visibility of fluorescent objects, or flood lighting.

21. The apparatus of claim 1, wherein the lens is to protect and cover the printed circuit board and light emitting diodes.

22. The apparatus of claim 2, wherein the first portion emits bright white light, the second portion emits red light, and the third portion emits ultra-violet light.

23. The apparatus of claim 9, wherein the adjustable clamp includes a bracket having an aperture, a threaded rod disposed through the aperture to facilitate adjusting the clamp, the threaded rod having a first end to be rotated to translate a second end, the second end including a disc to facilitate attachment of the adjustable clamp.

24. The apparatus of claim 10, wherein the pivot includes a second flange protruding from the housing and a third flange operatively coupled to a clamp, the second and third flanges including concentric apertures through which a second threaded rod is disposed to facilitate pivoting the light fixture.

25. The apparatus of claim 24, wherein the third flange is operatively coupled to the clamp via a threaded rod to facilitate rotation of the light fixture.

26. The apparatus of claim 11, wherein the removable power source is disposed within a compartment of the housing, the compartment to be protected by a removable cover defining a second face of the housing, the removable cover attached via a fastener.
